(19) United States
(12) Patent Application Publication
(10) Pub. No.: US 2006/0110197 A1
(43) Pub. Date: May 25, 2006

(54) Automatic document transportation device

(75) Inventors: Yoshitaka Nose, Kyoto-shi (JP); Naritoshi Takamatsu, Nara-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: Murata Kikai Kabushiki Kaisha, Kyoto-shi (JP)

(21) Appl. No.: 11/257,036

(22) Filed: Oct. 25, 2005

(30) Foreign Application Priority Data
Nov. 22, 2004 (JP) 2004-337350

(51) Int. Cl. G03G 15/00

(52) U.S. Cl. 399/367; 399/370

(57) ABSTRACT

An automatic document transportation device (ADF) includes a transportation path, a resist roller, transportation rollers, a scanning unit, a document discharge roller and a document length sensor. The transportation path is formed from a document tray to a document discharge tray. After a leading edge of an original document fed into the transportation path from the document tray makes contact with a standstill roller surface of the resist roller and a skew of the original document is corrected, the resist roller rotates to nip and transport the original document. The transportation rollers are arranged appropriately along the transportation path downstream of the resist roller, and nip and transport the original document. The scanning unit scans the transported original document. The document discharge roller discharges the scanned original document onto the document discharge tray.

### BACKGROUND OF THE INVENTION

1. Field of the Invention

The present invention relates to an automatic document transportation device in a scanner, a facsimile machine and a copying machine or the like, which transports an original document on a document tray through a transportation path to a scanning position and onto a document discharge tray.

2. Description of the Related Art

A scanner, a facsimile machine and a copying machine or the like include an automatic document transportation device such as an Automatic Document Feeder (ADF) for sequentially feeding a plurality of original documents. By using the automatic document transportation device, the plurality of original documents stacked on a document tray can be transported continuously and automatically to a scanning position.

FIG. 8 is a cross-sectional view illustrating a structure of an ADF of a copy-and-facsimile Multi Function Peripheral (MFP) 900. An original document on a document tray 901 is transported by the ADF to a document discharge tray 902 provided below the document tray 901, from an upper side to a lower side in a U-turn manner. While the original document is being transported, an image of the original document is scanned by an image scanning unit such as a Charge-Coupled Device (CCD). Specifically, as illustrated in the drawing, a transportation path 903 is formed from the document tray 901 to the document discharge tray 902. The original documents on the document tray 901 are fed into the transportation path 903 by document feed rollers 904A and 904 arranged near an inlet of the transportation path 903. The original documents fed into the transportation path 903 are transported continuously along the transportation path 903 by a resist roller 905 and transportation rollers 906. Then, the original documents are discharged onto the document discharge tray 902 by a document discharge roller 907. While the original document fed into the transportation path 903 from the document tray 901 is being transported along the transportation path 903, an image scanning process is executed on one side of the original document by a CCD scanning unit 908. Downstream of the CCD scanning unit 908, an image scanning process is executed on the other side of the original document by a Contact Image Sensor (CIS) scanning unit 909.

A sensor is provided on the document tray 901 for distinguishing a document size. When original documents of different sizes are placed on the document tray 901, the sensor cannot distinguish the document size. Therefore, in the ADF, a read sensor 910, a document length sensor 911 and a document width sensor 912 are arranged along the transportation path 903 for automatically distinguishing the document size before an image scanning process of the original document is carried out. The read sensor 910 detects a leading edge of the transported original document. After a prescribed period of time elapses from the detection of the leading edge of the transported original document, the read sensor 910 starts a scanning operation of the CCD scanning unit 908. A document length is distinguished according to a presence or an absence of a detection of the original document by the document length sensor 911 at a point of time when the leading edge of the original document is detected by the read sensor 910. Meanwhile, the document width sensor 912 includes a plurality of sensors arranged in a width direction of the transportation path 903. A document width is distinguished according to a presence or an absence of a detection of the original document by each of the sensors of the document width sensor 912. In accordance with the distinguished results of the document length and the document width, a control unit (not shown) distinguishes the document size before the scanning process of the original document is carried out.

Further, the document length can be distinguished according to an elapse of a period of time from when the document length sensor 911 detects a leading edge of an original document until when the document length sensor 911 detects a trailing edge of the original document. Although not illustrated in the drawing, a reversal path can be formed from a downstream side to an upstream side of the CCD scanning unit 908. In a first pass of the original document, the document size can be distinguished by a pre-scanning process of the CCD scanning unit 908. Then, the original document can be returned via the reversal path. In a second pass of the original document, an image scanning process can be carried out by the CCD scanning unit 908.

However, according to the conventional automatic document transportation device, image information scanned by the CCD scanning unit 908 is transmitted from an image scanning control unit to a main body control unit. The document size information is preferably transmitted to the main body control unit prior to the transmission of the image information considering a data volume of the image information being large, a data transmission speed from the image scanning control unit to the main body control unit, and processes such as a printing operation and facsimile transmission carried out by the main body control unit. Therefore, a transportation path length from a scanning position of the CCD scanning unit 908 to a detection position of the leading edge of the original document by the read sensor 910 is required to have a certain length. As a result, the transportation path length from the document length sensor 911 to the scanning position of the CCD scanning unit 908 becomes long. As illustrated in the drawing, the transportation path 903 is formed such that an outlet is located inward from an inlet. Furthermore, the document tray 901 is provided at the inlet. As a result, the original documents discharged onto the document discharge tray 902 are difficult to confirm visually and difficult to be taken out.

According to the above-described conventional automatic document transportation device, the document length can be distinguished according to an elapse of a period of time from when the document length sensor 911 detects the leading edge of the original document until when the document length sensor 911 detects the trailing edge of the original document. Depending on a degree of a bent or a skew of the original document when the original document is resisted, unevenness generates in a period of time from when the document length sensor 911 detects the leading edge of the original document until when the original document is nipped by the resist roller 905 and starts being transported. Thus, there exists a drawback that an error occurs in the distinguished document length. According to the above-described conventional automatic document transportation device in which the reversal path is formed and the image scanning process is carried out by passing the original document twice, when different sized original documents are mixed, the pre-scanning process is required to be carried out for each original document. Therefore, there exists a drawback that a long period of time is required for the image scanning process.

### SUMMARY OF THE INVENTION

In order to overcome the problems described above, preferred embodiments of the present invention permit a document size to be distinguished reliably and an original document discharged from an outlet of a transportation path to be easily confirmed visually and to be easily taken out.

According to a first aspect of the present invention, an automatic document transportation device includes a transportation path, a resist roller, transportation rollers, a scanning unit, a document discharge roller and a document length sensor. The transportation path is formed from a document tray to a document discharge tray. After a leading edge of an original document fed into the transportation path from the document tray makes contact with a standstill roller surface of the resist roller and a skew of the original document is corrected, the resist roller rotates to nip and transport the original document. The transportation rollers are arranged appropriately along the transportation path downstream of the resist roller. The transportation rollers nip and transport the original document by rotating in synchronism with the resist roller. The scanning unit scans the transported original document. The document discharge roller discharges the scanned original document onto the document discharge tray. The document length sensor detects a presence or an absence of the original document at a detection position on the transportation path. The document length sensor detects the presence or the absence of the original document at the detection position on the transportation path when the resist roller has rotated a prescribed number of times for nipping and transporting the original document.

According to a second aspect of the present invention, a resist sensor is arranged on the transportation path directly upstream of the resist roller. The resist sensor detects the leading edge of the original document fed into the transportation path. After a prescribed period of time elapses from when the resist sensor detects the leading edge of the original document, the resist roller starts rotating.

According to a third aspect of the present invention, a document width sensor is arranged on the transportation path upstream of the scanning unit. The document width sensor detects a width of the transported original document.

According to the first aspect of the present invention, the document length sensor detects the presence or the absence of the original document at the detection position when the resist roller has rotated a prescribed number of times for nipping and transporting the original document. Therefore, compared with the conventional automatic document transportation device which cannot distinguish the document length until the read sensor detects the leading edge of the original document, the automatic document transportation device according to the first aspect of the present invention can distinguish the document length regardless of a detection position of a read sensor. As a result, the original document discharged from the outlet of the transportation path can be easily confirmed visually and can be easily taken out. Moreover, compared with the conventional automatic document transportation device which distinguishes the document length according to an elapse of a period of time from when the document length sensor detects the leading edge of the original document until when the document length sensor detects the trailing edge of the original document, according to the first aspect of the present invention, a position where the leading edge of the original document reaches when the resist roller has rotated a prescribed number of times for nipping and transporting the original document has a smaller error resulting from a bend or a skew of the resisted original document. As a result, the document size can be distinguished reliably. Moreover, compared with the conventional automatic document transportation device which has the reversal path and carries out an image scanning process by passing the original document twice, the automatic document transportation device according to the first aspect is not required to carry out a pre-scanning process for each original document when different sized original documents are mixed. As a result, a period of time required for an image scanning process can be reduced.

According to the second aspect of the present invention, the resist roller starts rotating after a prescribed period of time elapses from when the resist sensor detects the leading edge of the original document. Therefore, by appropriately setting the prescribed period of time, an error resulting from a bend or a skew of the resisted original document can be reduced even more. As a result, the document size can be distinguished more reliably.

According to the third aspect of the present invention, the automatic document transportation device includes the document length sensor and the document width sensor. Therefore, by combining detection results of the document length sensor and the document width sensor, the document size and a transported direction of the transported original document can be distinguished even more reliably.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a cross-sectional view illustrating a structure of an upper portion of a copy-and-facsimile MFP according to a preferred embodiment of the present invention.

FIG. 2 is an enlarged cross-sectional view illustrating a structure of an ADF.

FIG. 3A is a view illustrating an A3 sized original document having a document length L1 and a document width W1. FIG. 3B is a view illustrating an A4 sized original document having a document length L2 and a document width W2.

FIG. 4 is a schematic view illustrating a layout of the ADF.

FIG. 5 is a schematic view illustrating a state in which an ADF cover is removed and various original documents are placed on a tray of the ADF.

FIG. 6 is a block diagram illustrating a control configuration of the copy-and-facsimile MFP.

FIG. 7 is a chart used for distinguishing an original document.

FIG. 8 is a cross-sectional view illustrating an ADF of a conventional copy-and-facsimile MFP.

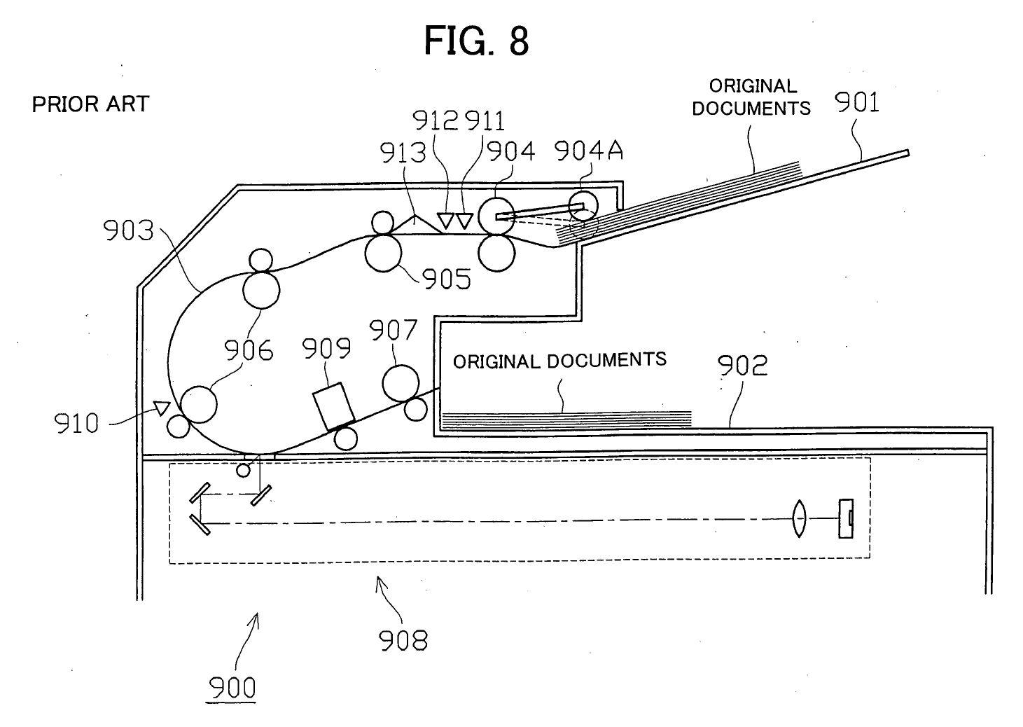

### DETAILED DESCRIPTION OF PREFERRED EMBODIMENTS

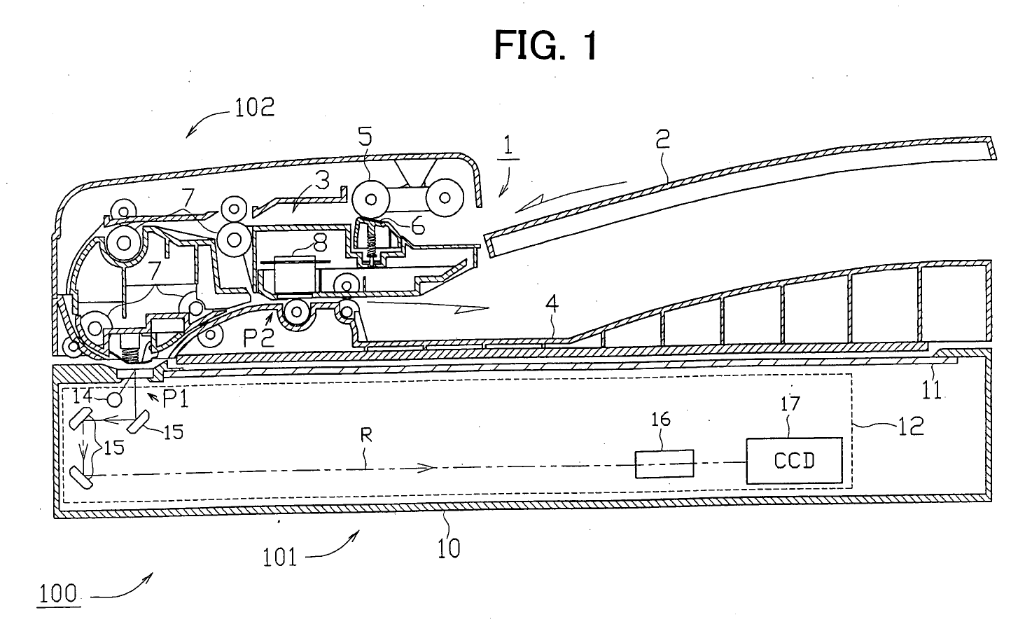

A copy-and-facsimile MFP 100 includes an automatic document transportation device according to a preferred embodiment of the present invention. As illustrated in FIG. 1, the copy-and-facsimile MFP 100 includes a scanning table 101 and a document pressing cover 102. The scanning table 101 functions as a Flat Bed Scanner (FBS). The document pressing cover 102 is attached on the scanning table 101 in a manner capable of being opened and closed. Although not illustrated in the drawing, the copy-and-facsimile MFP 100 also includes an operation panel, a main body and a paper feed cassette, or the like. The operation panel is operated for, for example, entering a start of a scanning process of an original document. The main body includes an image printing unit and a transmission unit, or the like. The image printing unit prints an image onto recording paper. The transmission unit electrically transmits an image. The paper feed cassette feeds recording paper for printing a scanned image. In the copy-and-facsimile MFP 100, an automatic document transportation device is formed by an ADF 1 provided inside the document pressing cover 102. An original document on a document tray 2 is transported by the ADF 1 to a document discharge tray 4 provided below the document tray 2, from an upper side to a lower side in a U-turn manner. An image scanning process is carried out while the original document is being transported.

In the scanning table 101, a platen glass 11 is arranged on an upper surface of a substantially rectangular parallelepiped housing 10. A CCD scanning unit 12 is accommodated inside the housing 10. The CCD scanning unit 12 is a reduction optical system scanning unit. As illustrated in the drawing, the CCD scanning unit 12 includes a light source 14, reflecting mirrors 15, a light-gathering lens 16 and a CCD image sensor 17. The light source 14 irradiates light to a scanning position P1. The reflecting mirrors 15 guide reflected light R from the original document to a prescribed direction. The light-gathering lens 16 focuses the reflected light R. The CCD image sensor 17 converts the focused light into an electric signal and outputs the electric signal. When the CCD scanning unit 12 functions as the FBS, the CCD scanning unit 12 moves horizontally with respect to the platen glass 11 to scan an original document placed on the platen glass 11. When using the ADF 1, the CCD scanning unit 12 moves to the scanning position P1 to scan an image of an original document transported through the transportation path 3. Then, the reflected light R from the original document is guided to the CCD image sensor 17 and an image is formed. Further, although not illustrated in the drawing, an analog-to-digital conversion and a shading process or the like are executed on an image signal, which has been scanned by the CCD scanning unit 12 and converted into an electric signal. Then, the image signal is printed out onto the recording paper by the image printing unit of a printer or the like. Alternatively, the image signal is transmitted electrically by the transmission unit of a Coder-and-Decoder (CODEC) or the like.

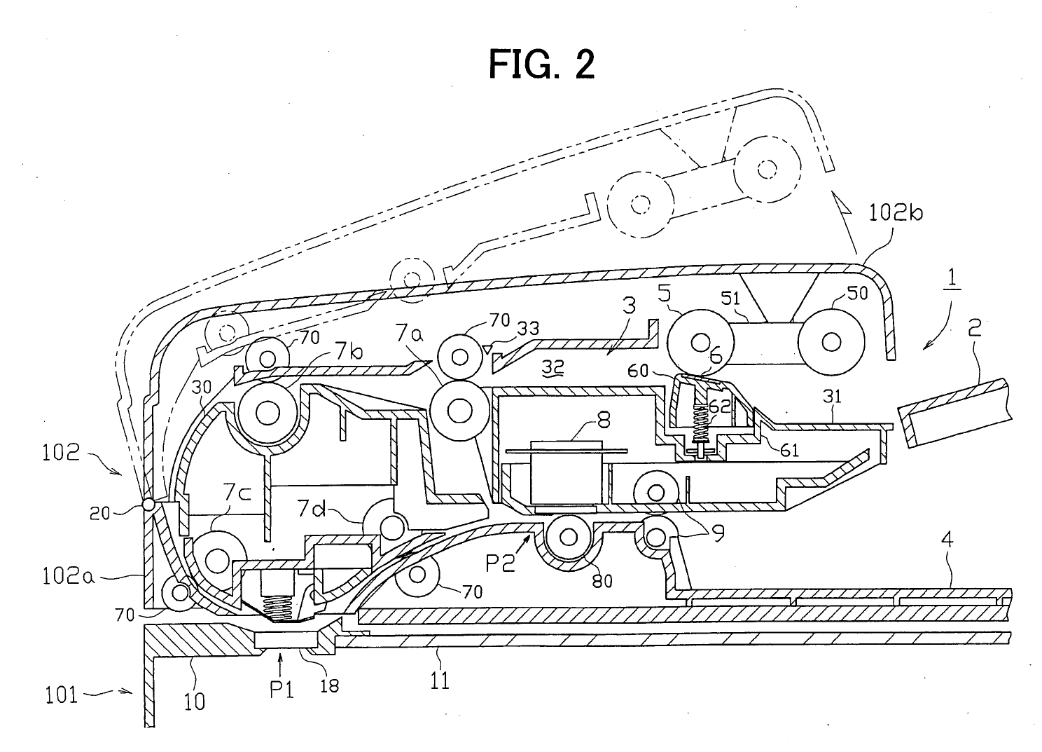

As illustrated in FIG. 1 and FIG. 2, the automatic document transportation device is provided as the ADF 1 in the document pressing cover 102. The automatic document transportation device continuously transports an original document to scanning positions P1 and P2. The automatic document transportation device includes the document tray 2, the document discharge tray 4, a transportation path 3, a document feed roller 5, a separating pad 6, transportation rollers 7, the CCD scanning unit 12 (scanning unit), a CIS scanning unit 8 and discharge rollers 9. The document tray 2 and the document discharge tray 4 are arranged vertically in two stages. The transportation path 3 is formed in a sideways letter-U shape from the document tray 2 to the document discharge tray 4. The document feed roller 5 and the separating pad 6 are arranged near an inlet of the transportation path 3. The document feed roller 5 and the separating pad 6 separate the original documents fed from the document tray 2 by nipping the original documents in a thickness direction. The transportation rollers 7 are arranged appropriately along the transportation path 3. The transportation rollers 7 nip and transport the original document. The CCD scanning unit 12 is arranged at an outer side of the transportation path 3, directly downstream of a U-turn part of the transportation path 3. The CCD scanning unit 12 scans a first side of the transported original document. The CIS scanning unit 8 is arranged at an inner side of the transportation path 3, at a downstream of the CCD scanning unit 12. The CIS scanning unit 8 scans a second side of the transported original document at the scanning position P2. The document discharge rollers 9 are arranged near an outlet of the transportation path 3. The document discharge rollers 9 nip the scanned original document and discharge the original document onto the document discharge tray 4. The original document fed into the transportation path 3 from the document tray 2 by the ADF 1 is transported along the sideways letter-U shaped transportation path 3 and reversed so as to make a U-turn from an upper side to a lower side. Then, the original document reaches the scanning position P1. When the original document passes the scanning position P1, the CCD scanning unit 12 scans an image on the first side of the original document. The original document is transported further along the transportation path 3 and reaches the scanning position P2. When the original document passes the scanning position P2, the CIS scanning unit 8 scans an image on the second side of the original document. Then, the original document is discharged onto the document discharge tray 4 located below the document tray 2. As described above, an image scanning process can be carried out on both sides of the original document by passing the original document once, in other words, by a so-called one pass.

The document tray 2 is arranged on an upper portion of the document pressing cover 102. The document tray 2 is slightly slanted towards a direction in which the original document is fed. A plurality of original documents before the scanning process are staked on an upper surface of the document tray 2. When a user places an original document on the document tray 2, the user places a leading edge of the original document at a lower end of the slanted document tray 2 so that the leading edge of the original document is inserted into the inlet of the transportation path 3. Further, although not illustrated in the drawing, a movable guide is arranged on the document tray 2. The movable guide regulates a position of the original document in a width direction of the original document and prevents a skew of the original document.

The transportation path 3 is formed in a sideways letter-U shape so as to connect the document tray 2 and the document discharge tray 4 provided vertically in two stages. The transportation path 3 passes over a platen glass 18 at the scanning position P1 located directly downstream of the U-turn part. The transportation path 3 then passes the scanning position P2 at the downstream of the scanning position P1. Then, the transportation path 3 leads to the document discharge tray 4. A paper guide 30 and an intermediate guide 31 are provided inside the document pressing cover 102 and form an inner guide surface of the transportation path 3. A cover frame 102a and an ADF cover 102b of the document pressing cover 102 form an outer guide surface of the transportation path 3. An original document having a prescribed thickness can pass through the transportation path 3.

The cover frame 102^{a} is a housing of the document pressing cover 102. The paper guide 30 and the intermediate guide 31 or the like are arranged on the cover frame 102a. The outer guide surface of the transportation path 3 and the document discharge tray 4 are formed integrally with the cover frame 102a. Meanwhile, the ADF cover 102b mainly forms an upper portion of the housing of the document pressing cover 102. The ADF cover 102b is provided on the cover frame 102a in a manner capable of being swung with a downstream side of a document transportation direction as a center of the swing.

Specifically, as illustrated in FIG. 2, the ADF cover 102b constitutes a sidewall and a top plate of the document pressing cover 102 at a side where the ADF 1 is provided. A lower end of the sidewall part of the ADF cover 102b is pivotally supported on the cover frame 102a via a spindle 20. Therefore, by lifting up an upstream side of the transportation direction of the ADF cover 102b, in other words, by lifting up a side of the ADF cover 102b located next to the document tray 2, the ADF cover 102b can be opened and closed with the spindle 20 as a center of the swing. By opening the ADF cover 102b, an inner structure of the document pressing cover 102, such as the separating pad 6 and the transportation rollers 7, is exposed. Accordingly, maintenance work and removal of jammed paper can be carried out. The cover frame 102a and a lower surface of the ADF cover 102b constitutes the outer guide surface of the transportation path 3.

The paper guide 30 forms the inner guide surface of the transportation path 3 near the U-turn part. The transportation rollers 7 or the like are provided appropriately along the paper guide 30. The paper guide 30 is fixed on the cover frame 102a. Meanwhile, the intermediate guide 31 forms the inner guide surface of the transportation path 3 upstream and downstream of the U-turn part. That is, an upper surface of the intermediate guide 31 is an inner guide surface near the inlet of the transportation path 3, and a lower surface of the intermediate guide 31 is an inner guide surface near the outlet of the transportation path 3. The above-described structure of the transportation path 3 is just one preferred example and may be changed to a structure of a known transportation path. For example, in place of the paper guide 30, a transportation drum having a large diameter may be provided.

The document feed roller 5 is arranged near the inlet of the transportation path 3. The document feed roller 5 rotates while making contact with the original document fed from the document tray 2 and feeds the original document into the transportation path 3. The separating pad 6 is pressed against the document feed roller 5, and multi-fed original documents are separated. Although detail is not illustrated in the drawing, a silicon or an Ethylene-Propylene-Diene Methylene Linkage (EPDM) roller body is mounted on a metal roller shaft via a one-way clutch to form the document feed roller 5. The document feed roller 5 is arranged at the outer side of the document transportation path 3 near the inlet of the transportation path 3. The roller shaft of the document feed roller 5 is supported on the ADF cover 102b. When the ADF cover 102b is opened, the document feed roller 5 also swings upward along with the ADF cover 102b.

Meanwhile, a coefficient of friction of the separating pad 6 with respect to the original document is lower than a coefficient of the roller body of the document feed roller 5 with respect to the original document and higher than a coefficient of friction between the original documents. For example, the separating pad 6 is made of urethane resin. The separating pad 6 is mounted on an upper surface of a separating pad holder 60. A mounting hole 61 is formed on an upper surface of the intermediate guide 31. The separating pad holder 60 is fit in the mounting hole 61 in a manner capable of being rocked. The separating pad holder 60 is urged upward by a coil spring 62 provided inside the mounting hole 61. Accordingly, the separating pad 6 is pressed against the roller body of the document feed roller 5. When the original documents pass through the document feed roller 5 and the separating pad 6, the separating pad holder 60 swings downward according to a thickness of the original documents. The original documents fed into the transportation path 3 by the document feed roller 5 and the separating pad 6 are separated one sheet at a time and transported sequentially. The original document fed into the transportation path 3 is nipped by the transportation rollers 7 and transported to scanning positions P1 and P2. When the original document is nipped by the transportation rollers 7, the roller body of the document feed roller 5 becomes rotatable in a document transportation direction with respect to the roller shaft by the one-way clutch. Accordingly, the rotation of the roller body of the document feed roller 5 follows the original document transported by the transportation rollers 7 so that the transportation of the original document is not influenced by the nip of the document feed roller 5 and the separating pad 6. As a result, a vibration of the original document is prevented from generating.

A pickup roller 50 is arranged upstream of the document feed roller 5. The pickup roller 50 is supported rotatably by pickup arms 51, which are swung vertically by a document feed clutch (not shown). The pickup arms 51 are a pair of arms which sandwich the pickup roller 50 rotatably. A base end of the pickup arms 51 are held rotatably on the roller shaft of the document feed roller 5. A tip end of the pickup arms 51 extend towards the document tray 2 and support the pickup roller 53. Under a standby state when the original document is placed onto the document tray 2, the tip end of the pickup arms 51 elevate and the pickup roller 50 separates from the intermediate guide 31. When picking up the original document, the tip end of the pickup arms 51 swing downward so that the pickup roller 50 descends to make contact with an uppermost sheet of the original documents on the document tray 2. The pickup roller 50 rotates while making contact with the original documents on the document tray 2 and feeds the original documents to the document feed roller 5.

Although not illustrated in the drawing, a document set sensor detects a presence or an absence of an original document on the document tray 2. In accordance with a detection signal, a control unit controls a movement of the pickup roller 50, the pickup arms 51, the document feed roller 5 and a document feed clutch (not shown). A drive force from a drive source such as a motor is transmitted to the roller shaft of the document feed roller 5. The drive force is further transmitted to the roller shaft of the pickup roller 50 by a belt transmitting mechanism (not shown). In addition, when lowering the pickup arms 51, the document feed clutch is engaged and the drive force is also transmitted to the pickup arms 51. The pickup arms 51 are urged upward by a spring. When the document feed clutch is disengaged, the pickup arms 51 return to an uppermost position by the urging force of the spring and becomes under the standby state.

Each of the transportation rollers 7 is formed by a plurality of roller bodies fixed on a roller shaft in an axial direction at a prescribed interval between one another. For example, roller bodies made of silicon or EPDM are fixed on a metal roller shaft. A number and positions of the roller bodies are set appropriately according to, for example, a size of an original document to be transported. In the preferred embodiment, four transportation rollers 7a, 7b, 7c and 7d are supported axially on the paper guide 30 that constitutes the inner guide surface. With respect to each of the transportation rollers 7a, 7b, 7c and 7d, driven rollers 70 are provided at the outer guide surface so as to make contact with each of the transportation rollers 7a, 7b, 7c and 7d, respectively. The transportation rollers 7a, 7b, 7c and 7d rotate in synchronism with one another. The original document is nipped by the transportation rollers 7a, 7b, 7c and 7d and the driven rollers 70 and transported along the transportation path 3. In the same manner as the document feed roller 5, two driven rollers 70 facing two transportation rollers 7a and 7b located upstream of the U-turn part are supported axially by the ADF cover 102b. As illustrated in the drawing, when the ADF cover 102b is opened, the document feed roller 5 and the two driven rollers 70 also swing upward. A contacting state of the document feed roller 5 and the separating pad 6 and a contacting state of the transportation rollers 7a and 7b and the driven rollers 70 are released, respectively. Accordingly, maintenance work and removal of jammed paper can be carried out.

The transportation roller 7a is provided at an uppermost stream side among the transportation rollers 7. The transportation roller 7a functions as a so-called resist roller. The outer guide surface of the transportation path 3 at the upstream of the transportation roller 7a is caved and a vertical width of the transportation path 3 is widened to form a resist space 32. A resist sensor 33 is provided directly upstream of the transportation roller 7a. The resist sensor 33 detects the leading edge of the original document, which has been separated by the document feed roller 5 and the separating pad 6 and fed into the transportation path 3. The leading edge of the original document makes contact with a nip part of the transportation roller 7a. In this case, the transportation roller 7a is under a stopped state. The original document is transported further, and as a result, the original document bends. However, the bend of the original document is permitted by the resist space 32. By the original document being bent as described above, a skew of the leading edge of the original document is corrected in accordance with a roller surface of the transportation roller 7a. Then, after a prescribed number of counts is counted from when the leading edge of the original document is detected by the resist sensor 33, in other words, under a timing in which the leading edge of the original document makes contact with the nip part of the transportation roller 7a again, an electromagnetic clutch (not shown) of the transportation roller 7a is engaged. Accordingly, the transportation roller 7a is connected to a drive source such as a motor and starts rotating. The skew of the original document is corrected as described above, and then, the original document is transported.

The CIS scanning unit 8 uses a CIS. Although details are not illustrated in the drawing, the CIS scanning unit 8 is a stationary scanning unit which focuses the reflected light from the original document irradiated by the light source onto a photoconductive element by a focusing fiber and carries out a scanning process. By being provided in the intermediate guide 31, the CIS scanning unit 8 is located at the inner side of the transportation path 3. In the lateral cross-section of the ADF 1, the CIS scanning unit 8 is provided between and below the separating pad 6 and the transportation roller 7a provided directly downstream of the separating pad 6, and between the scanning position P1 of the CCD scanning unit 12 and the document discharge rollers 9. The CIS adopted in the CIS scanning unit 8 has a narrow subject depth. At the outer side of the transportation path 3, a platen roller 80 is provided facing the CIS scanning unit 8 across the transportation path 3. The transported original document is contacted against a scanning surface of the CIS scanning unit 8 by the platen roller 80, and an image scanning process is carried out. As illustrated in FIG. 2, a side of the intermediate guide 31 located next to the document tray 2 can be opened with a proximity of a downstream edge of an upper surface of the intermediate guide 31 as a center of the swing. By opening the intermediate guide 31, the CIS scanning unit 8 also swings upward.

A pair of document discharge rollers 9 are provided downstream of the CIS scanning unit 8. In the same manner as the transportation rollers 7 or the like, a roller body made of silicon or EPDM is mounted on a metal roller shaft to form each of the document discharge rollers 9. The document discharge roller 9 located at the inner side of the transportation path 3 is supported by the intermediate guide 31. The document discharge roller 9 located at the outer side of the transportation path 3 is supported by the cover frame 102a. The document discharge rollers 9 are making contact with and facing one another. After the image scanning process, the document discharge rollers 9 discharge the scanned original document from the transportation path 3 onto the document discharge tray 4. As illustrated in the drawing, the document discharge rollers 9 are provided approximately below the separating pad 6. The position of the document discharge rollers 9 on the transportation path 3 is displaced with respect to the separating pad 6 and the separating pad holder 60. That is, the document discharge roller 9 provided on the intermediate guide 31 is provided not to interfere with the mounting hole 61 where the separating pad holder 60 is fit in.

Next, a description will be made of a sensor of the ADF1 arranged to distinguish a document size. There exists a limit as to a document size capable of being scanned by the CCD scanning unit 12 and the CIS scanning unit 8. An original document larger than an A4 size, for example, a B4 sized original document and an A3 sized original document, can be transported only in a document length direction. In the following description, for example, an A4 size portrait means to transport an A4 sized original document in a document width direction. Moreover, an A4 size landscape means to transport an A4 sized original document in a document length direction. The ADF 1 supports seven types of original documents (document size and transportation direction) as standard sized original documents: A5 size portrait, B5 size landscape, B5 size portrait, A4 size landscape, A4 size portrait, B4 size landscape and A3 size landscape. The ADF 1 is required to distinguish a type of an original document before scanning an image of the original document.

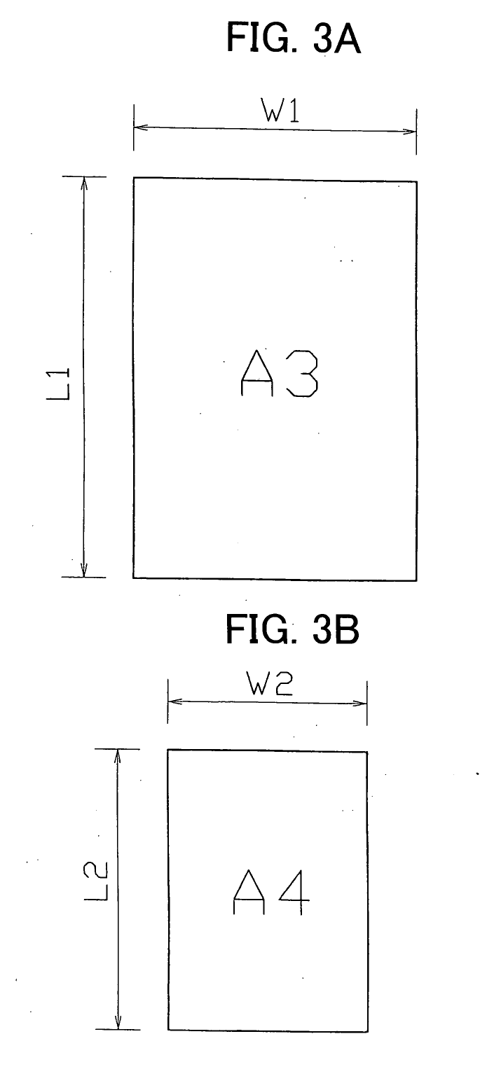

A document length sensor 34 and a plurality of document width sensors 35 are arranged along the transportation path 3 of the ADF 1. Before an image of an original document is scanned by the CCD scanning unit 12, the document size is distinguished automatically. For example, as illustrated in FIGS. 3A and 3B, suppose that an A3 sized original document has a document length L1 and a document width W1, and an A4 sized original document has a document length L2 and a document width W2. Then, the document width W1 of the A3 sized original document and the document length L2 of the A4 sized original document are the same. The ADF 1 can transport the A4 sized original document in either a portrait direction or a landscape direction. In other words, the ADF 1 can transport the A4 sized original document in both a document length direction and a document width direction. Therefore, for example, when just a document width of the transported original document is detected by the document width sensor 35, the ADF 1 cannot distinguish whether the original document is A3 size portrait or A4 size landscape. Thus, the document length and the document width of the transported original document are detected by the document length sensor 34 and the document width sensors 35, and the document size and the transportation direction are distinguished. For example, if the transported original document is detected to be longer than the document length L2 of the A4 sized original document by a detection signal of the document length sensor 34, the transported original document can be distinguished to be B4 size landscape or A3 size landscape in accordance with a detection signal of the document width sensor 35.

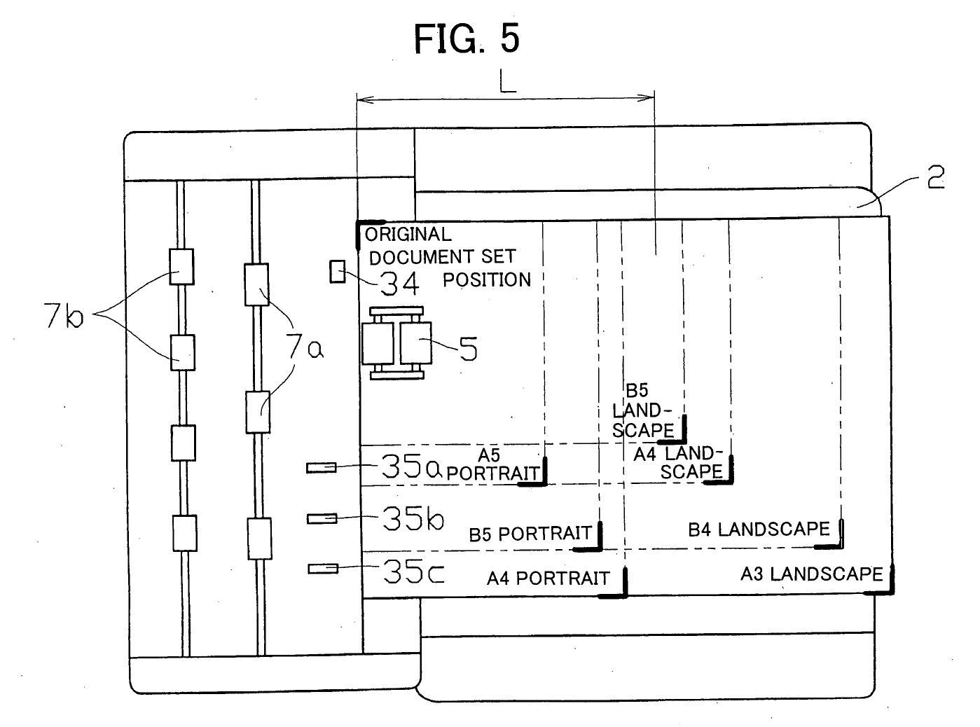

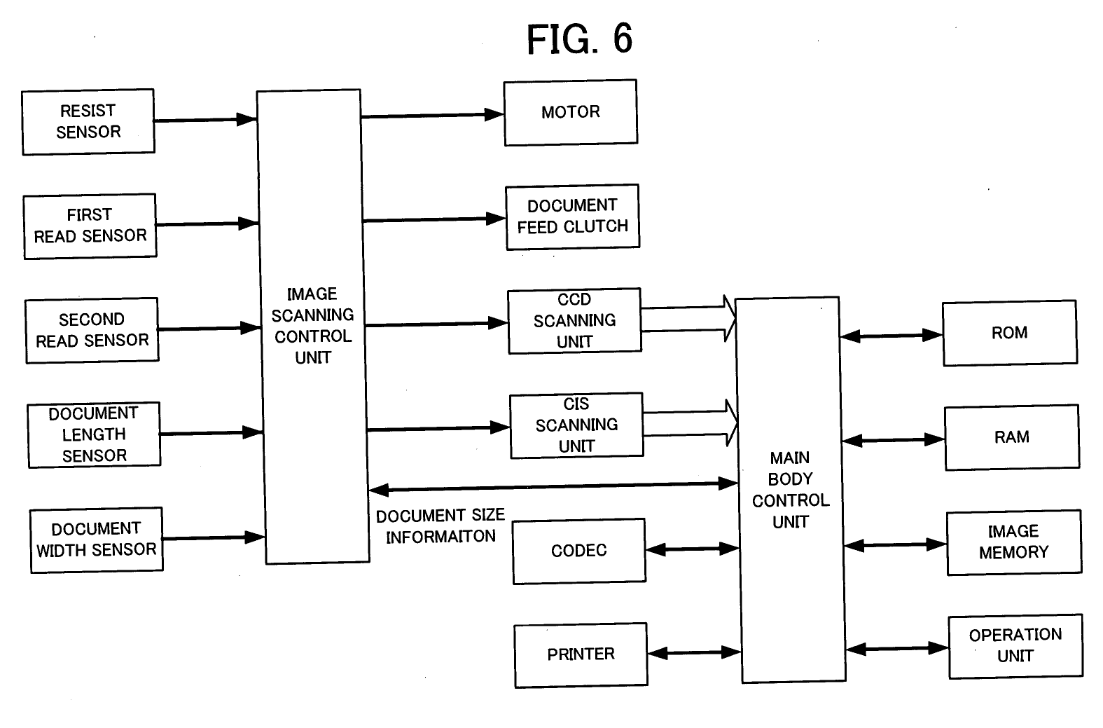

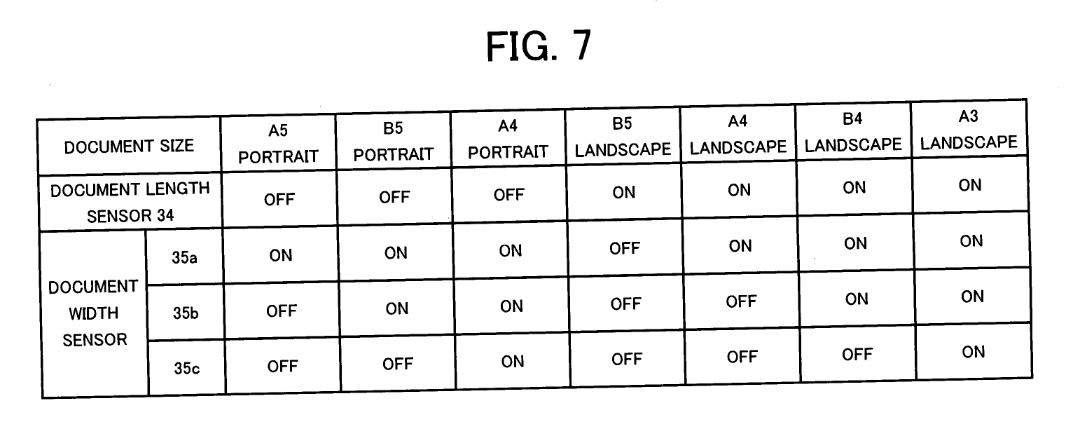

As illustrated in FIG. 5 and FIG. 6, the document length sensor 34 and the document width sensors 35 are provided between the document feed roller 5 and the transportation roller 7a. As illustrated in FIG. 6, an image scanning control unit receives the detection signals from the document length sensor 34 and the document width sensors 35 and distinguishes the document size of the transported original document. Specifically, as described above, after a prescribed number of counts is counted from a detection of the leading edge of the original document fed from the document tray 2 by the resist sensor 33, the transportation roller 7a is connected to the motor and starts rotating. Then, when the transportation roller 7a rotates for a prescribed number of times, the document length sensor 34 detects a presence or an absence of the original document at a detection position of the document length sensor 34. A determination as to whether or not the transportation roller 7a has rotated for a prescribed number of times is made in accordance with, for example, a number of steps of the motor. The detection position of the document length sensor 34 is a position located away by a transportation path length L from a position where the leading edge of the transported original document is assumed to reach when the transportation roller 7a has rotated for the prescribed number of times. The transportation path length L of the ADF 1 is longer than a document width of an A4 sized original document and shorter than a document length of a B5 sized original document (refer to FIG. 5). As illustrated in FIG. 7, when the document length sensor 34 detects a presence of the original document and a detection signal of the document length sensor 34 is switched ON, a determination can be made that a length of the transported original document in the transportation direction exceeds the transportation path length L and that the transported original document is one of four types, i.e. B5 size landscape, A4 size landscape, B4 size landscape or A3 size landscape. Meanwhile, when the document length sensor 34 detects an absence of the original document and a detection signal of the document length sensor 34 is switched OFF, a determination can be made that a length of the transported original document in the transportation direction is shorter than the transportation path length L and that the transported original document is one of three types, i.e. A5 size portrait, B5 size portrait or A4 size portrait.

An error of the position where the leading edge of the transported original document is assumed to reach when the transportation roller 7a has rotated for the prescribed number of times is approximately millimeter at maximum. The error of the position is not significant enough to cause an error in the determination of the document size. Therefore, a detection can be made accurately as to whether the length of the transported original document in the transportation direction exceeds a document width of an A4 sized original document or shorter than a document length of a B5 sized original document. Furthermore, since an error in the detected document size is small, the transportation path length L can be minimized and a size of the ADF 1 can be reduced.

Meanwhile, the document width sensor 35 includes a plurality of sensors arranged in the width direction of the transportation path 3 from one end to a prescribed detection position of the transportation path 3 so as to respond to each document width of various document sizes. The document width sensor 35 detects a presence or an absence of the original document at the detection positions. Specifically, the document width sensor 35 includes three document width sensors 35a, 35b and 35c. The detection positions of the document width sensors 35a, 35b and 35c are arranged in a direction orthogonal to the transportation direction of the transported original document. A presence or an absence of the original document is detected at each of the detection positions. The document width sensor 35a detects a presence or an absence of an original document at a detection position located away from an original document set position more than a document width of a B5 sized original document and shorter than a document width of an A4 sized original document. The document width sensor 35b detects a presence or an absence of an original document at a detection position located away from the original document set position more than a document width of an A4 sized original document and shorter than a document width of a B4 sized original document. The document width sensor 35c detects a presence or an absence of an original document at a detection position located away from the original document set position more than a document width of a B4 sized original document and shorter than a document width of an A3 sized original document. As illustrated in FIG. 7, for example, when the document width sensor 35a detects a presence of an original document and the detection signal of the document width sensor 34a is switched ON, a determination can be made that the length of the transported original document in a direction orthogonal to the transportation direction exceeds a document width of a B5 sized original document and that the transported original document is one of six types, i.e. A5 size portrait, B5 size portrait, A4 size landscape, A4 size portrait, B4 size landscape or A3 size landscape. Meanwhile, when the document length sensor 35a detects an absence of an original document and the detection signal of the document width sensor 34a is switched OFF, a determination can be made that the length of the transported original document in the direction orthogonal to the transportation direction is equal to or shorter than a document width of a B5 sized original document and that the transported original document is B5 size landscape.

In accordance with a combination of the detection signals of the document length sensor 34 and the three document width sensors 35a, 35b and 35c, as illustrated in FIG. 7, the transported original document can be specified to one type. The image scanning control unit distinguishes the original document in accordance with the detection signals, and transmits document size information including a document size and a transportation direction to the main body control unit of the copy-and-facsimile MFP 100. Then, the main body control unit selects paper in accordance with the document size information, and prints out the scanned image or carries out facsimile transmission. As described above, the image scanning control unit can automatically distinguish the document size of the transported original document in accordance with the detection signals of the document length sensor 34 and the document width sensors 35 arranged along the transportation path 3. As a result, even when different sized original documents are placed on the document tray 2, the document size of each of the original documents can be distinguished automatically.

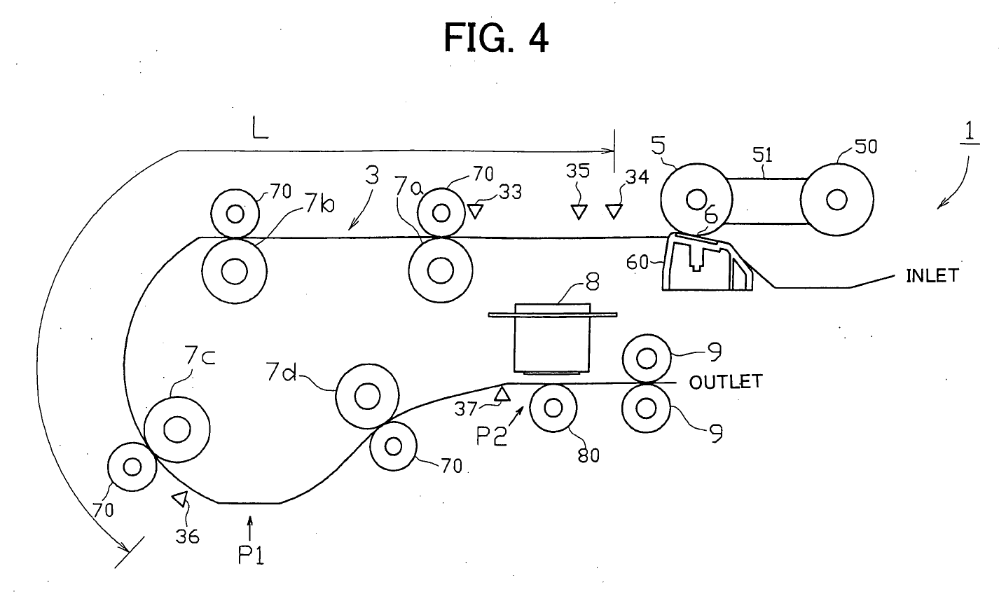

As illustrated in FIG. 4, a first read sensor 36 is provided at the transportation path 3 directly upstream of the scanning position P1. The first read sensor 36 detects the leading edge and the trailing edge of the transported original document. In accordance with the detection signal, the image scanning control unit controls the CCD scanning unit 12 so that, for example, after a prescribed number of counts is counted from the detection of the leading edge of the original document, the CCD scanning unit 12 starts an image scanning process and after a prescribed number of counts is counted from the detection of the trailing edge of the original document, the CCD scanning unit 12 stops the image scanning process. In the same manner, a second read sensor 37 is provided at the transportation path 3 directly upstream of the scanning position P2. In accordance with a detection signal of the second read sensor 37, the image scanning control unit controls the CIS scanning unit 8.

Each of the image information scanned by the CCD scanning unit 12 and the CIS scanning unit 8 is transmitted from the image scanning control unit to the main body control unit. Considering a data volume of the image information being large, a data transmission speed from the image scanning control unit to the main body control unit and processes of the main body control unit such as a printing operation and facsimile transmission, the above-described document size information is preferable to be transmitted to the main body control unit prior to the transmission of the image information. Therefore, the position where the leading edge of the transported original document is assumed to reach when the transportation roller 7a has rotated for the prescribed number of times, in other words, the position located away from the detection position of the document length sensor 34 by the transportation path length L, is required to be located upstream of the scanning position P1.

Further, the structure of the copy-and-facsimile MFP 100 of the above-described preferred embodiment is just one preferred example of the automatic document transportation device relating to the present invention. There are variations to the above-described automatic document transportation device without departing from the scope of the present invention. For example, the automatic document transportation device of the present invention can be implemented in a single function machine such as a copying machine, a facsimile machine and a scanner.

While the present invention has been described with respect to preferred embodiments thereof, it will be apparent to those skilled in the art that the disclosed invention may be modified in numerous ways and may assume many embodiments other than those specifically set out and described above. Accordingly, it is intended by the appended claims to cover all modifications of the present invention that fall within the true spirit and scope of the invention.

What is claimed is:

1. An automatic document transportation device, comprising:
a transportation path formed from a document tray to a document discharge tray;
a resist roller, wherein after a leading edge of an original document fed into the transportation path from the document tray makes contact with a standstill roller surface of the resist roller and a skew of the original document is corrected, the resist roller rotates to nip and transport the original document;
transportation rollers, which are arranged appropriately along the transportation path downstream of the resist roller, and nip and transport the original document by rotating in synchronism with the resist roller;
means for scanning the transported original document;
a document discharge roller arranged to discharge the scanned original document onto the document discharge tray; and
a document length sensor arranged to detect a presence or an absence of the original document at a detection position on the transportation path when the resist roller has rotated for a prescribed number of times to nip and transport the original document.

2. The automatic document transportation device according to claim 1, wherein a resist sensor is arranged on the transportation path directly upstream of the resist roller and detects the leading edge of the original document fed into the transportation path; and
wherein the resist roller starts rotating after a prescribed period of time elapses from when the resist sensor detects the leading edge of the original document.

3. The automatic document transportation device according to claim 2, wherein a vertical width of the transportation path is widened to form a resist space at the transportation path upstream of the resist roller.

4. The automatic document transportation device according to claim 3, wherein a document width sensor is arranged on the transportation path upstream of the means for scanning and detects a width of the transported original document.

5. The automatic document transportation device according to claim 4, wherein the document width sensor is arranged at three positions.

6. The automatic document transportation device according to claim 5, wherein the document width sensor is arranged in a direction orthogonal to a transportation direction of the transported original document.

7. The automatic document transportation device according to claim 1, wherein a determination as to whether or not the resist roller has rotated for the prescribed number of times to nip and transport the original document is carried out in accordance with a number of steps of a motor, which is a drive source.

8. An automatic document transportation device, comprising:
a transportation path formed from a document tray to a document discharge tray;
an outer guide surface arranged to guide an outer side of the transportation path;
an inner guide surface arranged to guide an inner side of the transportation path;
a resist roller, wherein after a leading edge of an original document fed into the transportation path from the document tray makes contact with a standstill roller surface of the resist roller and a skew of the original document is corrected, the resist roller rotates to nip and transport the original document;
transportation rollers, which are arranged appropriately along the transportation path downstream of the resist roller, and nip and transport the original document by rotating in synchronism with the resist roller;
a first scanning means for scanning a first side of the transported original document;
a second scanning means for scanning a second side of the transported original document;
a document discharge roller arranged to discharge the scanned original document onto the document discharge tray; and
a document length sensor arranged to detect a presence or an absence of the original document at a detection position on the transportation path when the resist roller has rotated for a prescribed number of times to nip and transport the original document.

9. The automatic document transportation device according to claim 8, wherein the second scanning means is an image sensor, and the image sensor is arranged on an intermediate guide which forms the inner guide surface.

10. The automatic document transportation device according to claim 9, wherein the image sensor is provided downstream in a document transportation direction of the first means for scanning.

11. The automatic document transportation device according to claim 10, wherein accompanying an upward swing of the intermediate guide with a proximity of a downstream edge of an upper surface of the transportation path as a center of the swing, the image sensor also swings upward.

12. The automatic document transportation device according to claim 11, wherein a resist sensor is arranged on the transportation path directly upstream of the resist roller and detects the leading edge of the original document fed into the transportation path; and
wherein the resist roller starts rotating after a prescribed period of time elapses from when the resist sensor detects the leading edge of the original document.

13. The automatic document transportation device according to claim 12, wherein a vertical width of the transportation path is widened to form a resist space at the transportation path upstream of the resist roller.

14. The automatic document transportation device according to claim 13, wherein a document width sensor is arranged on the transportation path upstream of the first means for scanning and detects a width of the transported original document.

15. The automatic document transportation device according to claim 14, wherein the document width sensor is arranged at three positions.

16. The automatic document transportation device according to claim 15, wherein the document width sensor is arranged in a direction orthogonal to a transportation direction of the transported original document.

17. The automatic document transportation device according to claim 8, wherein a determination as to whether or not the resist roller has rotated for the prescribed number of times to nip and transport the original document is carried out in accordance with a number of steps of a motor, which is a drive source.

18. The automatic document transportation device according to claim 17, further comprising a document feed roller and a separating pad arranged to separate and feed original documents;
wherein a coefficient of friction of the separating pad with respect to the original document is lower than a coefficient of friction of a roller body of the document feed roller with respect to the original document and higher than a coefficient of friction of the original documents.

19. The automatic document transportation device according to claim 18, further comprising a separating pad holder on which the separating pad is mounted.

20. The automatic document transportation device according to claim 19, wherein the separating pad holder is mounted to swing downward according to a thickness of the original document.
